(19) United States
(12) Patent Application Publication
(10) Pub. No.: US 2011/0208899 A1
(43) Pub. Date: Aug. 25, 2011

(54) MEMORY WRITING SYSTEM AND METHOD

(75) Inventor: Wataru Uchida, Tokyo (JP)

(73) Assignee: OKI SEMICONDUCTOR CO., LTD., Tokyo (JP)

(21) Appl. No.: 13/024,561

(22) Filed: Feb. 10, 2011

(30) Foreign Application Priority Data
Feb. 19, 2010 (JP) 2010-034611

(51) Int. Cl. G06F 12/00

(52) U.S. Cl. 711/103; 711/E12.008

(57) ABSTRACT

Memory writing system and method determining an optimum data amount per one-time data transmission to one memory writer to enable optimization of communication efficiency and write speed, include: setting the amount of data to be transmitted per one-time transmission from a writer controller to different values for respective memory writers; transmitting data of each of the data amounts from the writer controller to a corresponding one of the memory writers; measuring, for each of the data amounts, a processing time required for the writer controller to transmit data to the corresponding memory writer and a data write time of the corresponding memory writer; obtaining, for each of the data amounts, a correlation between the processing time and the data write time based on respective measured values; setting an optimum data amount based on the correlation to satisfy a desired data write time condition; and, after the optimum data amount is set, sequentially transmitting data of the optimum data amount from the writer controller to the memory writers.

### BACKGROUND OF THE INVENTION

1. Field of the Invention

The present invention relates to a system and method for writing data into nonvolatile memories, such as flash memories.

2. Description of the Related Art

For mass production of large scale integrated circuits (LSIs) equipped with flash memories, a writing system is constructed on a part of a production line to write data, such as programs, into the flash memories. The writing system may be automated, but to do so is costly. For this reason, in the case where the number of LSIs to be produced can be manually coped with, a conventional writing system may be constructed as shown in FIG. 1.

In the writing system of FIG. 1, LSIs 1₁ to 1ₙ, each equipped with a flash memory, are one-to-one connected to flash writers 2₁ to 2ₙ, respectively. Each of the flash writers 2₁ to 2ₙ is connected to one writer controller 4 via a distributor 3. The writer controller 4 holds data to be written into each of the LSIs 1₁ to 1ₙ. As the writer controller 4 is operated by a user of a production line, it performs a control operation to supply the data to the respective flash writers 2₁ to 2ₙ through the distributor 3, thereby allowing the data to be written into the respective LSIs 1₁ to 1ₙ. At the time that the writer controller 4 recognizes completion of the writing into all the LSIs 1₁ to 1ₙ, the user disconnects the respective LSIs 1₁ to 1ₙ from the corresponding flash writers 2₁ to 2ₙ. Then, the user connects LSIs 1₁ to 1ₙ into which data is written to the corresponding flash writers 2₁ to 2ₙ and repeats the writing of the data in the same sequence.

In this conventional writing system, the number n of connectable LSIs 1₁ to 1ₙ is generally on the order of several to several tens due to restrictions by communication standards, etc. For example, for the writing into a total of twenty thousand LSIs using a system in which the LSIs are connectable 20 by 20, it is necessary to repeat the above sequence 1000 times. For this reason, it is required to shorten a write time for a plurality of memories, as shown in Japanese Patent Kokai No. 2004-102438 (patent literature 1) and Japanese Patent Kokai No. H11-250684 (patent literature 2).

In order to make the production line efficient under the condition of maintaining the configuration of the writing system as it is, the shortening of a write time per one sequence is a problem to be solved. On the other hand, there is a limit in the size of write data that each flash writer can receive through one-time communication. In this regard, the writer controller may always set the size of write data to be transmitted to the limit. In this case, the write time is minimized, but channel occupancy of the writer controller is increased because the writer controller and the distributor are generally interconnected via one communication channel. This is not preferable in terms of communication efficiency. Therefore, there is a need to promote the optimization of the communication efficiency and write time.

### SUMMARY OF THE INVENTION

However, in the conventional writing system, no consideration is given to writing in an optimum state. For the convenience of description of this point, it is here assumed that five LSIs 1₁ to 1₅ are connected to the flash writers 2₁ to 2₅ in the conventional writing system of FIG. 1. FIG. 2 shows communications between the writer controller 4 and the flash writers 2₁ to 2₅ in the aforementioned connection state. The writer controller 4 includes a writer controller commander 41 and a write processor 42 therein. Also, the distributor 3 shown in FIG. 1 is omitted. For data writing, first, the writer controller 4 divides write data by a predetermined size and sequentially transmits every write data of the predetermined size to each flash writer 2₁ to 2₅. If the flash writer 2₁ receives write data of the predetermined size, then it writes the received data into the LSI 1₁. Similarly, if the flash writer 2₂ receives write data of the predetermined size, then it writes the received data into the LSI 1₂. The flash writers 2₃ to 2₅ also write data into the LSIs 1₃ to 1₅ in the same manner. The writer controller 4 inquires writing results from the flash writers 2₁ to 2₅. After confirming writing results fed back from all the flash writers 2₁ to 2₅, the writer controller 4 performs second-time writing of data of the predetermined size. The above operation is repeated until write data is exhausted.

In this writing system, a write data transmission process and a writing result reception process are executed for writing of data of the predetermined size, as shown in FIG. 3. In FIG. 3, Tt is a time until the writer controller 4 prepares and transmits write data of the predetermined size for one LSI, Tw1 is a time until each flash writer 2₁ to 2₅ receives data and completes writing of the received data, and Tw2 is a period for which the writer controller 4 receives a writing result from every flash writer. A write time Tw is defined as Tw=Tw1+Tw2.

The writer controller 4 proceeds to the writing result reception process immediately after performing the write data transmission process. This is because the writer controller 4 cannot expect when writing results will be fed back from the flash writers 2₁ to 2₅. As a result, since the writer controller 4 occupies the communication channel for the writing result reception process until receiving writing results, a smaller write data size per one sequence is advantageous to communication efficiency. However, in the case where the write data size is too small, data writing by flash writers having already received data may be ended before completion of the write data transmission process, resulting in generation of standby times of those flash writers, thereby making it impossible to promote the shortening of the write time. That is, although the write data size needs to be set to an optimum value, it is difficult to determine the optimum value in advance. This is because the optimum value is dependent on a variety of parameters, such as a processing speed of the writer controller 4, a communication speed of the communication channel, a processing speed of each flash writer 2₁ to 2₅, and a write speed of the flash memory equipped in each LSI 1₁ to 1₅. Consequently, in the conventional writing system, there is a problem that no consideration is given to writing in an optimum state.

Therefore, the present invention has been made in view of the above problems, and it is an object of the present invention to provide a memory writing system and method which can determine an optimum data amount per one-time data transmission to one memory writer to enable optimization of communication efficiency and write speed.

In accordance with an aspect of the present invention, the above and other objects can be accomplished by the provision of a memory writing system including a writer controller and a plurality of memory writers, the writer controller sequentially transmitting data to the memory writers over a communication channel and repeating this transmission operation, each of the memory writers, whenever receiving data transmitted from the writer controller, writing the received data into a nonvolatile memory, the system further including a first setting component which sets the amount of data to be transmitted per one-time transmission from the writer controller to different values for the respective memory writers, a first transmission controller which transmits data of each of the data amounts from the writer controller to a corresponding one of the memory writers, a measurement component which measures, for each of the data amounts, a processing time required for the writer controller to transmit data to the corresponding memory writer and a data write time of the corresponding memory writer, a correlation detection component which obtains, for each of the data amounts, a correlation between the processing time and the data write time based on respective measured values of the processing time and data write time measured by the measurement component, a second setting component which sets an optimum data amount based on the correlation to satisfy a desired data write time condition, and a second transmission controller which sequentially transmits, after the optimum data amount is set, data of the optimum data amount from the writer controller to the memory writers.

In accordance with another aspect of the present invention, there is provided a memory writing method of a memory writing system, the memory writing system including a writer controller and a plurality of memory writers, the writer controller sequentially transmitting data to the memory writers over a communication channel and repeating this transmission operation, each of the memory writers, whenever receiving data transmitted from the writer controller, writing the received data into a nonvolatile memory, the method including a first setting step of setting the amount of data to be transmitted per one-time transmission from the writer controller to different values for the respective memory writers, a first transmission control step of transmitting data of each of the data amounts from the writer controller to a corresponding one of the memory writers, a measurement step of measuring, for each of the data amounts, a processing time required for the writer controller to transmit data to the corresponding memory writer and a data write time of the corresponding memory writer, a correlation detection step of obtaining, for each of the data amounts, a correlation between the processing time and the data write time based on respective measured values of the processing time and data write time measured at the measurement step, a second setting step of setting an optimum data amount based on the correlation to satisfy a desired data write time condition, and a second transmission control step of, after the optimum data amount is set, sequentially transmitting data of the optimum data amount from the writer controller to the memory writers.

According to the memory writing system and the memory writing method of the present invention, the writing data transmitting process and the writing result receiving process are performed in accordance with the optimum data amount obtained by the processing time required for the writer controller to transmit data to the corresponding memory writer and the data write time of the corresponding memory writer. Thus the data writing into the nonvolatile memory is realized while maintaining an optimum communication efficiency and an optimum writing speed.

### BRIEF DESCRIPTION OF THE DRAWINGS

FIG. 1 is a block diagram showing a conventional writing system;

FIG. 2 is a block diagram showing a system including an internal configuration of a writer controller in FIG. 1;

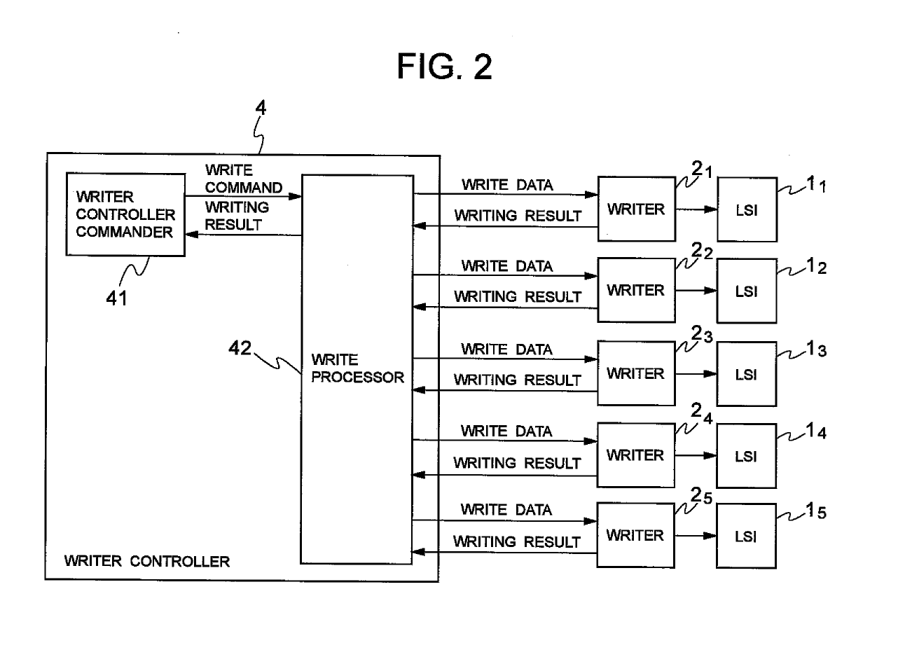

FIG. 3 is a timing diagram of a write data transmission process and a writing result reception process;

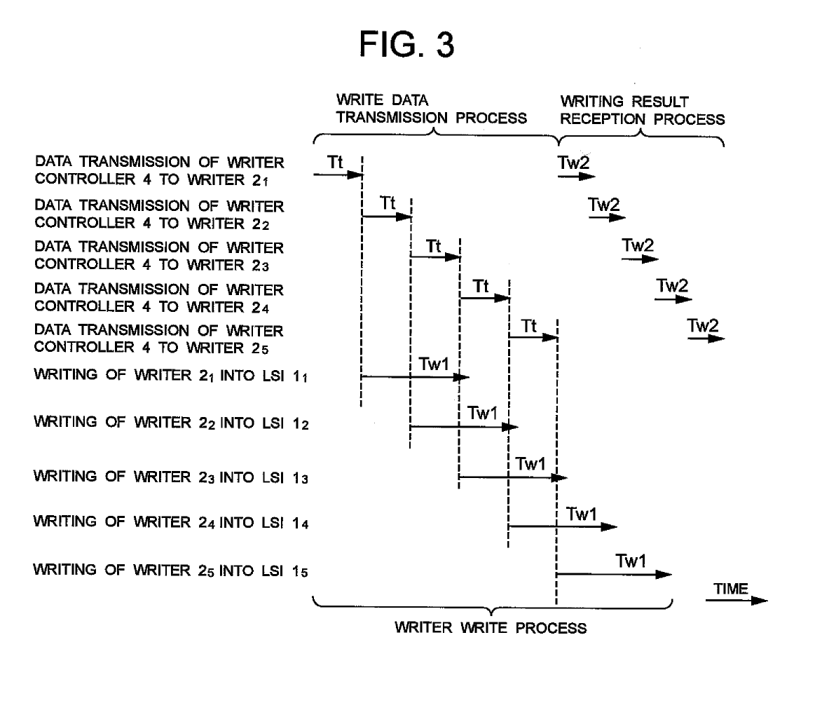

FIG. 4 is a block diagram showing an embodiment of the present invention;

FIG. 5 is a flow chart illustrating an optimum data size calculation operation of a writer controller in FIG. 4;

FIG. 6 is a flow chart illustrating a data write operation of the writer controller in FIG. 4;

FIG. 7 is a block diagram showing another embodiment of the present invention; and

FIG. 8 is a flow chart illustrating a data write operation of a writer controller in FIG. 7.

### DETAILED DESCRIPTION OF THE INVENTION

Now, exemplary embodiments of the present invention will be described in detail with reference to the annexed drawings.

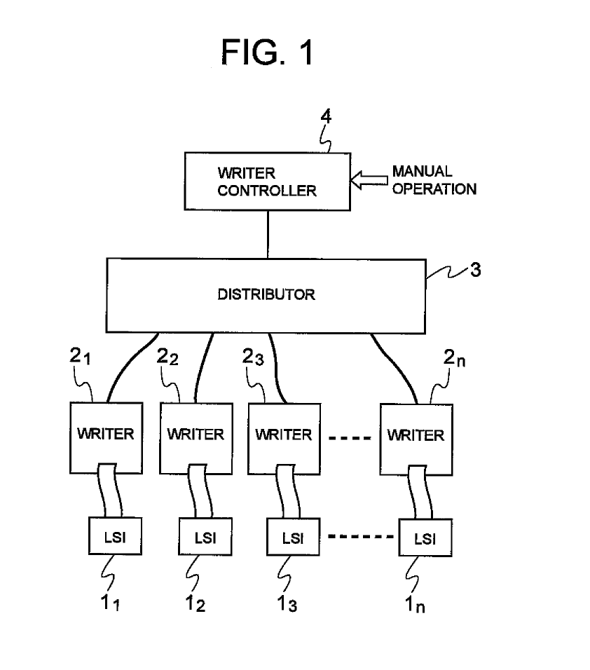

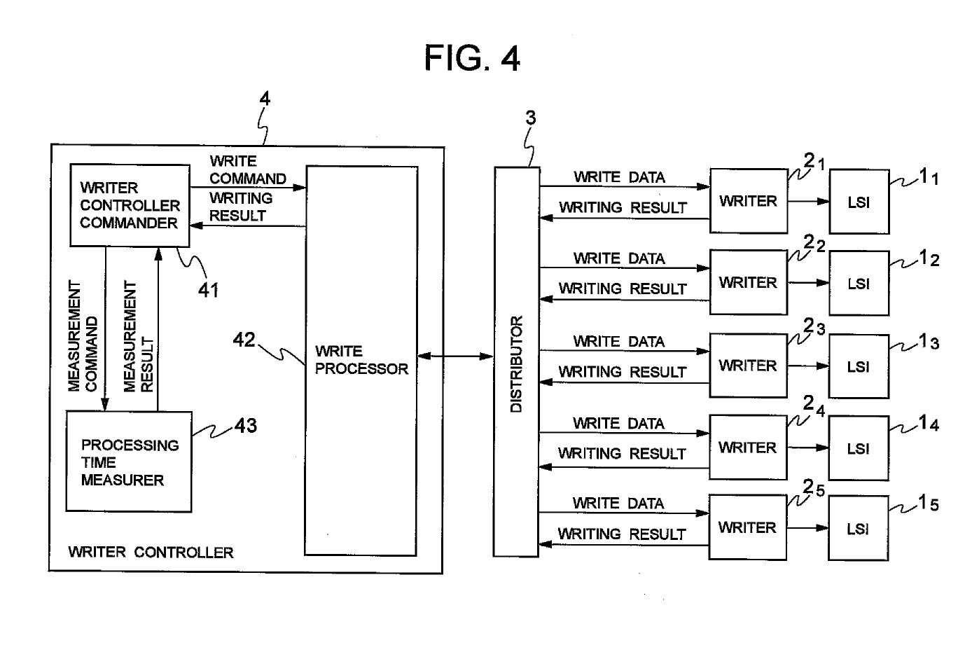

FIG. 4 shows a memory writing system of the present invention. This memory writing system corresponds to the same five LSIs 1₁ to 1₅, each having a flash memory, and includes flash writers 2₁ to 2₅, a distributor 3, and a writer controller 4, similarly to the system shown in FIG. 1.

The writer controller 4 includes a writer controller commander 41, a write processor 42, and a processing time measurer 43. The writer controller commander 41 controls the write processor 42 and the processing time measurer 43. The writer controller commander 41 generates commands including a write command to the write processor 42 such that the write processor 42 transmits data of the maximum size MAX_SIZE to each flash writer, and receives a writing result from each flash writer. The write processor 42 sequentially supplies write data to the flash writers 2₁ to 2₅ in response to the write command.

Also, the writer controller commander 41 generates a measurement command consisting of a start command and a stop command to the time measurer 43 such that the time measurer 43 measures a processing time. The time measurer 43 includes a timer (not shown), and starts time measurement of the timer in response to the start command and stops the measurement of the timer in response to the stop command. Then, the timer measurer 43 provides a time measured by the timer as the processing time to the writer controller commander 41.

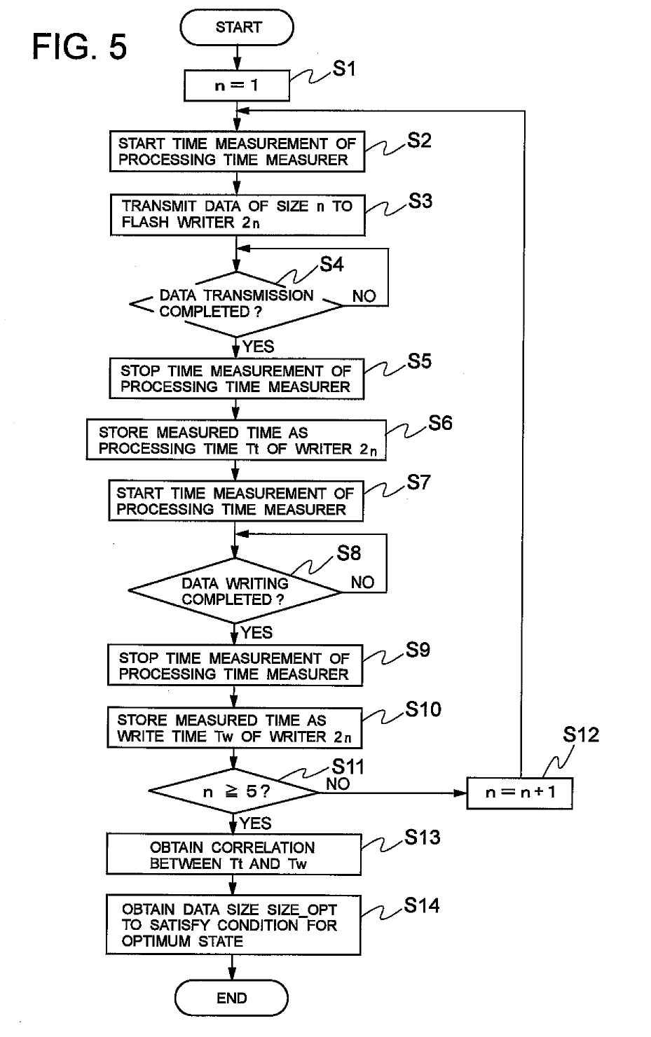

In the memory writing system of the present invention with this configuration, as shown in FIG. 5, first, the writer controller commander 41 sets a variable n to 1 (step S1) and starts the time measurement of the timer of the processing time measurer 43 (step S2). This is for starting measurement of the processing time of the writer controller 4 itself. Then, the writer controller commander 41 commands the write processor 42 to prepare data to be transmitted to a flash writer 2ₙ and transmit the prepared data to the flash writer 2ₙ (step S3). This data is transmitted from the write processor 42 to the flash writer 2ₙ through the distributor 3. Here, the size size_n of the data to be transmitted to the flash writer 2ₙ (n=1 to 5) is (MAX_SIZE/5)×n. That is, the size size_1 of the data to the flash writer 2₁ is MAX_SIZE/5, the size size_2 of the data to the flash writer 2₂ is 2(MAX_SIZE/5), the size size_3 of the data to the flash writer 2₃ is 3(MAX_SIZE/5), the size size_4 of the data to the flash writer 2₄ is 4(MAX_SIZE/5), and the size size_5 of the data to the flash writer 2₅ is MAX_SIZE.

At the time that the writer controller commander 41 detects completion of the data transmission from the write processor 42 to the flash writer 2ₙ (YES at step S4), it stops the time measurement of the timer of the processing time measurer 43 (step S5). The processing time of the writer controller, measured at this time, is provided as Tt to the writer controller commander 41. The writer controller commander 41 stores the processing time Tt for the flash writer 2ₙ (step S6).

Then, the writer controller commander 41 again starts the time measurement of the timer of the processing time measurer 43 (step S7). This is for starting measurement of a write time of the flash writer 2ₙ. When a writing result indicative of writing completion from the flash writer 2ₙ is fed back to the write processor 42 (YES at step S8), the writer controller commander 41 stops the time measurement of the timer of the processing time measurer 43 (step S9). The write time, measured at this time, is provided as Tw to the writer controller commander 41. The writer controller commander 41 stores the write time Tw for the flash writer 2ₙ (step S10).

The above steps S2 to S10 are carried out similarly with respect to each of the flash writers 2₂ to 2₅, in addition to the flash writer 2₁. That is, the writer controller commander 41 determines whether n is greater than or equal to 5 (step S11), and, if n<5, adds 1 to n (step S12) and then proceeds to step S2. On the other hand, if n·5, the writer controller commander 41 proceeds to the next step S13.

By the above operation, five measurements for the respective flash writers 2₁ to 2₅ can be provided as the write time Tw. Therefore, the writer controller commander 41 obtains a correlation between the write time Tw and the data size size_n through a method of least squares (step S13). The obtained correlation is expressed as a function, such as Tw(size_n).

It can be seen from this result that the equality of the processing time of the writer controller 4 and the write time indicates an optimum state of communication efficiency and write speed. As a result, a condition for the optimum state (desired data write time condition) is 4 Tt=Tw(size_n). In a write process, for example, if the writer controller 4 ends transmission of data to the flash writer 2₁, the flash writer 2₁ begins to write the data into the LSI 1₁, whereas the writer controller 4 sequentially transmits data to the other four writers 2₂ to 2₅. Therefore, it is preferable that, at the time that the data transmission to the writers 2₂ to 2₅ is completed, the flash writer 2₁ should end the writing into the LSI 1₁ and be ready to receive new data. Consequently, the equality of the write time Tw(size_n) of one flash writer and the data transmission processing time 4 Tt of four flash writers is a condition for the optimum state. A data size size_n to satisfy this condition is obtained as an optimum data size size_opt=size_n (step S14).

If the optimum data size size_opt is obtained in this manner, then the writer controller commander 41 executes transmission of data of the optimum data size size_opt per one-time transmission to each flash writer 2₁ to 2₅ as follows.

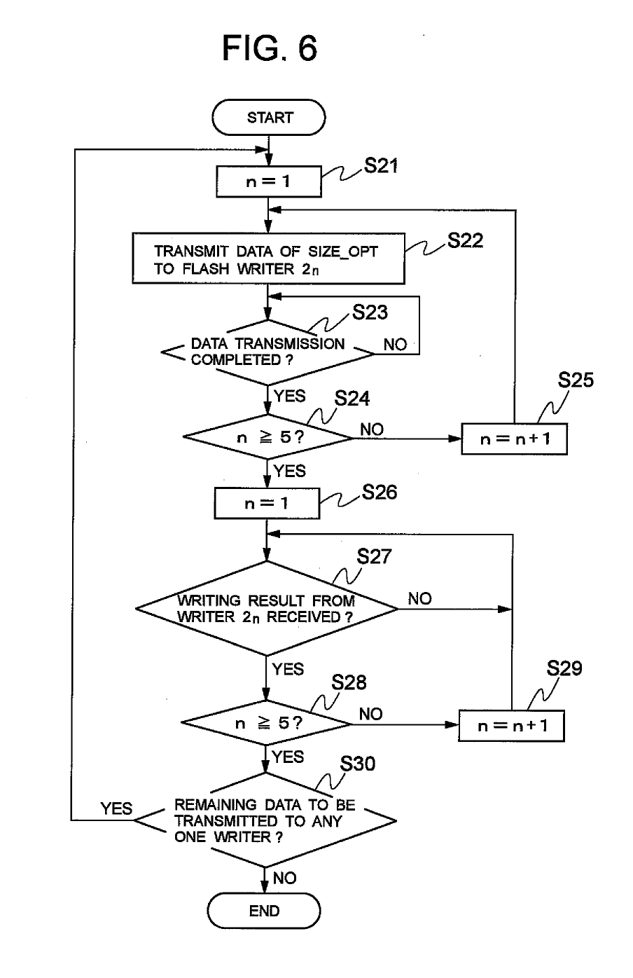

As shown in FIG. 6, first, the writer controller commander 41 sets the variable n to 1 (step S21). Then, if there is remaining data to be transmitted, the writer controller commander 41 commands the write processor 42 to prepare data of the data size size_opt to be transmitted to the flash writer 2ₙ and transmit the prepared data to the flash writer 2ₙ (step S22). At the time that the writer controller commander 41 detects completion of the data transmission from the write processor 42 to the flash writer 2ₙ (YES at step S23), it determines whether n is greater than or equal to 5 (step S24), and, if n<5, adds 1 to n (step S25) and then proceeds to step S22. On the other hand, if n·5, the writer controller commander 41 proceeds to the next step S26 because a write data transmission process has been carried out with respect to each flash writer 2₁ to 2₅.

The writer controller commander 41 sets the variable n to 1 (step S26) and determines whether a writing result indicative of writing completion has been received from the flash writer 2ₙ (step S27). If the write processor 42 has received the writing result from the flash writer 2ₙ, the writer controller commander 41 determines whether n is greater than or equal to 5 (step S28), and, if n<5, adds 1 to n (step S29) and then proceeds to step S27. On the other hand, if n·5, because a writing result reception process has been carried out with respect to each flash writer 2₁ to 2₅, the writer controller commander 41 determines whether there is data to be transmitted to at least one of the flash writers 2₁ to 2₅ (step S30). If there is data to be transmitted to at least one of the flash writers 2₁ to 2₅, the writer controller commander 41 returns to step S21 to repeat the above steps S21 to S30 until the data transmission to all the flash writers 2₁ to 2₅ is completed. Also, although not shown in FIG. 6, with respect to a flash memory to which data to be transmitted is exhausted, the writer controller commander 41 does not perform steps S22 and S23 and performs step S24 directly by bypassing those steps. Similarly, the writer controller commander 41 does not perform step S27 and performs step S28 directly by bypassing step S27.

In the case where there is no data to be transmitted to at least one of the flash writers 2₁ to 2₅, the data transmission has been completed with respect to all the flash writers 2₁ to 2₅ and the writing results have been received from all the flash writers 2₁ to 2₅.

As stated above, in the present embodiment, the write data transmission process and the writing result reception process are carried out based on a write data size obtained from measured values of the processing time Tt of the writer controller 4 and the write time Tw of each flash writer 2₁ to 2₅. Therefore, it is possible to realize data writing into LSIs under the condition that communication efficiency and write speed are optimum.

Also, the memory writing system of this embodiment can be inexpensively realized by modifying only a writer controller of a conventional system. In addition, the optimum write data size size_opt can be obtained at an actual write time. As a result, the optimum write data size size_opt can be obtained based on processing performance of each of the writer controller and flash writers, a communication speed of a communication channel and the number of flash writers connected, at the actual write time. Therefore, it is possible to realize data writing into LSIs in a more optimum state.

Also, if the write processor 42 has received the writing result from the flash writer 2ₙ at step S27 of the above embodiment, the writer controller commander 41 may directly transmit data of the data size size_opt to the flash writer 2ₙ when there is remaining data to be transmitted to the flash writer 2ₙ. In this case, after the data transmission, the writer controller commander 41 adds 1 to n, and proceeds to step S27 if n<5.

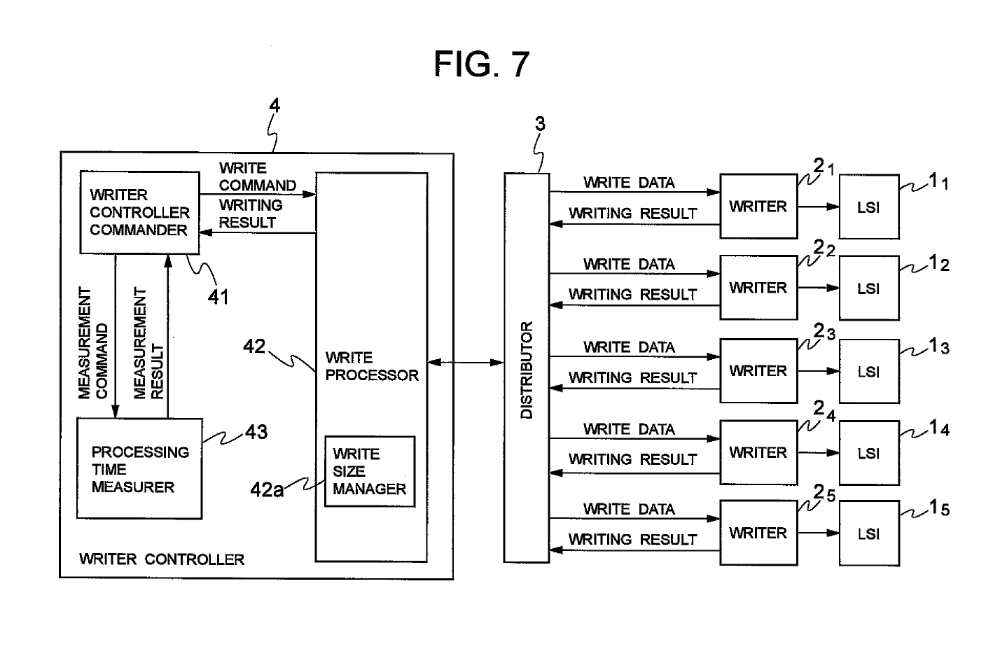

FIG. 7 shows a memory writing system according to another embodiment of the present invention. In this memory writing system, a write size manager 42a is provided in a write processor 42 of a writer controller 4. The write size manager 42a stores optimum data sizes size_opt(1) to size_opt(5) for respective flash writers 2₁ to 2₅.

Other components of the memory writing system of FIG. 7 are the same as those of the system shown in FIG. 4.

In this memory writing system of FIG. 7, first, steps S1 to S14 of FIG. 5 are performed to set an optimum data size size_opt.

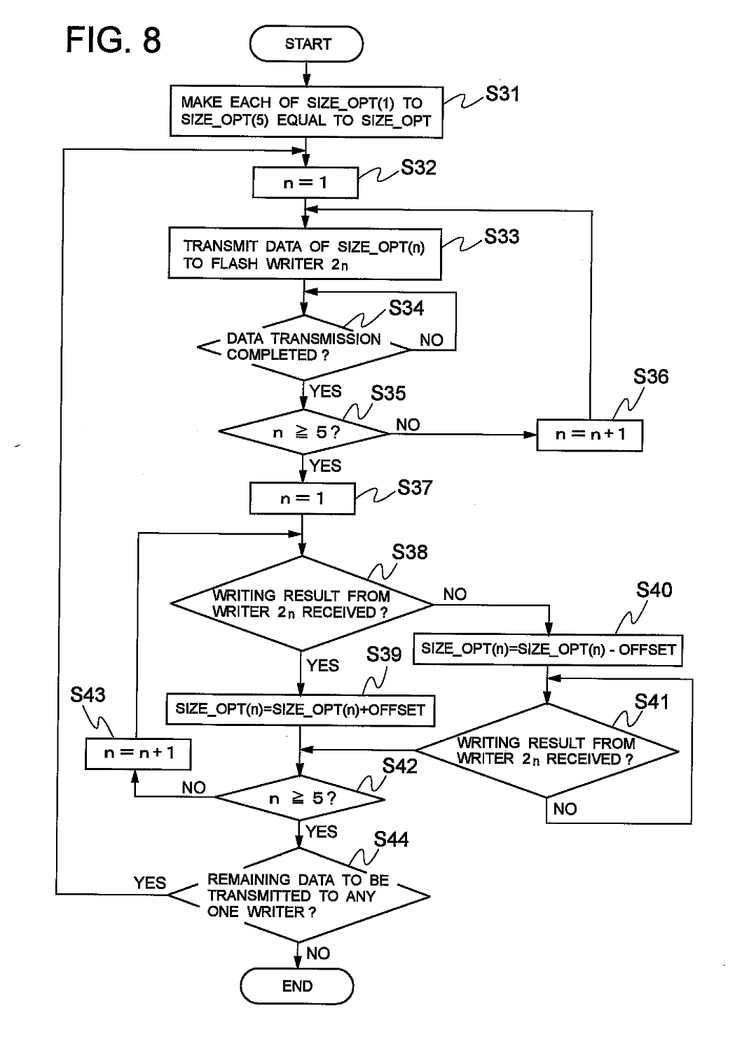

If the optimum data size size_opt is set at step S14, as shown in FIG. 8, the writer controller commander 41 makes each of size_opt(1) to size_opt(5) equal to the set optimum data size size_opt (step S31).

Thereafter, the writer controller commander 41 sets a variable n to 1 (step S32). Then, if there is remaining data to be transmitted, the writer controller commander 41 commands the write processor 42 to prepare data of the data size size_opt(n) to be transmitted to the flash writer 2ₙ and transmit the data of the data size size_opt(n) to the flash writer 2ₙ (step S33). At the time that the writer controller commander 41 detects completion of the data transmission from the write processor 42 to the flash writer 2ₙ (YES at step S34), it determines whether n is greater than or equal to 5 (step S35), and, if n<5, adds 1 to n (step S36) and then proceeds to step S33. On the other hand, if n·5, the writer controller commander 41 proceeds to the next step S37 because the write data transmission process has been carried out with respect to each flash writer 2₁ to 2₅.

The writer controller commander 41 sets the variable n to 1 (step S37) and determines whether a writing result indicative of writing completion has been received from the flash writer 2ₙ (step S38). This determination may be made at a certain time after the write transmission process is performed with respect to the flash writer 2ₙ. The certain time may be determined depending on the data size size_opt(n) and the correlation Tw(size_n) obtained by the method of least squares may be used as Tw(size_opt(n)). If the write processor 42 has received the writing result from the flash writer 2ₙ, the writer controller commander 41 increases the data size size_opt(n) by a predetermined value offset (step S39) and then proceeds to step S42. On the other hand, if the write processor 42 has not received the writing result from the flash writer 2ₙ, the writer controller commander 41 decreases the data size size_opt(n) by the predetermined value offset (step S40). The data sizes size_opt(n), which are results of the execution of steps S39 and S40, are stored in the write size manager 42a. After the execution of step S40, the writer controller commander 41 determines whether the writing result indicative of the writing completion has been received from the flash writer 2ₙ (step S41). If the writing result indicative of the writing completion has been received from the flash writer 2ₙ at step S41, the writer controller commander 41 proceeds to step S42.

The writer controller commander 41 determines at step S42 whether n is greater than or equal to 5, and, if n<5, adds 1 to n (step S43) and then proceeds to step S38. On the other hand, if n·5, because the writing result reception process has been carried out with respect to each flash writer 2₁ to 2₅, the writer controller commander 41 determines whether there is data to be transmitted to at least one of the flash writers 2₁ to 2₅ (step S44). If there is data to be transmitted to at least one of the flash writers 2₁ to 2₅, the writer controller commander 41 returns to step S32 to repeat the above steps S32 to S44 until the data transmission to all the flash writers 2₁ to 2₅ is completed.

Assuming that the optimum data size size_opt set at step S14 is, for example, 520 Byte and the predetermined value offset is, for example, 80 Byte, the data size size_opt(n) is size_opt(n)=520+80=600 Byte when the writing result indicative of the writing completion has been received from the flash writer 2ₙ at step S38. As a result, data of 600 Byte is transmitted in the next data transmission to the flash writer 2ₙ. On the other hand, in the case where the writing result indicative of the writing completion has not been received from the flash writer 2ₙ at step S38, the data size size_opt(n) is size_opt(n)=520−80=440 Byte. As a result, data of 440 Byte is transmitted in the next data transmission to the flash writer 2ₙ.

In this manner, by making the transmission size of write data smaller with respect to an LSI with a longer write time and larger with respect to an LSI with a shorter write time, it is possible to absorb a difference between write times resulting from a difference between inherent characteristics of LSIs. As a result, the write data transmission process and the writing result reception process are carried out based on a write data size which is obtained from measured values of the processing time Tt of the writer controller 4 and the write time Tw of each flash writer 2₁ to 2₅ and then optimized with respect to each flash writer 2₁ to 2₅. Therefore, it is possible to realize data writing into LSIs under the condition that communication efficiency and write speed are optimum for each LSI.

This memory writing system of FIG. 7 can be inexpensively realized by modifying only a writer controller of a conventional system. In addition, it is also possible to cope with a variation in transmission state of the communication channel during data writing.

Also, although the flash memories equipped in the LSIs 1₁ to 1ₙ have been described as nonvolatile memories in the above-stated respective embodiments, the present invention is not limited thereto. For example, the nonvolatile memories may be ROMs, PROMs or other types of nonvolatile memories.

As is apparent from the above description, according to a memory writing system and memory writing method of the present invention, a write data transmission process and a writing result reception process are carried out based on an optimum data amount obtained from measured values of a processing time of a writer controller required for data transmission to every memory writer and a data write time of each memory writer. Therefore, it is possible to realize data writing into nonvolatile memories under the condition that communication efficiency and write speed are optimum.

This application is based on Japanese Patent Application 2010-034611 which is herein incorporated by reference.

What is claimed is:

1. A memory writing system comprising a writer controller and a plurality of memory writers, the writer controller sequentially transmitting data to the memory writers over a communication channel and repeating this transmission operation, each of the memory writers, whenever receiving data transmitted from the writer controller, writing the received data into a nonvolatile memory, the system further comprising:
a first setting component which sets the amount of data to be transmitted per one-time transmission from the writer controller to different values for the respective memory writers;
a first transmission controller which transmits data of each of the data amounts from the writer controller to a corresponding one of the memory writers;
a measurement component which measures, for each of the data amounts, a processing time required for the writer controller to transmit data to the corresponding memory writer and a data write time of the corresponding memory writer;
a correlation detection component which obtains, for each of the data amounts, a correlation between the processing time and the data write time based on respective measured values of the processing time and data write time measured by the measurement component;
a second setting component which sets an optimum data amount based on the correlation to satisfy a desired data write time condition; and
second transmission controller which sequentially transmits, after the optimum data amount is set, data of the optimum data amount from the writer controller to the memory writers.

2. The memory writing system according to claim 1, wherein the second transmission controller increases/decreases the optimum data amount depending on a writing state of each of the memory writers.

3. The memory writing system according to claim 1, wherein the second transmission controller increases the optimum data amount by a predetermined value with respect to a corresponding one of the memory writers when a result of writing completion is received from the corresponding memory writer at a time corresponding to the optimum data amount after the data of the optimum data amount is transmitted to each of the memory writers, and decreases the optimum data amount by the predetermined value with respect to the corresponding memory writer when the result of writing completion is not received from the corresponding memory writer.

4. The memory writing system according to claim 2, wherein the second transmission controller increases the optimum data amount by a predetermined value with respect to a corresponding one of the memory writers when a result of writing completion is received from the corresponding memory writer at a time corresponding to the optimum data amount after the data of the optimum data amount is transmitted to each of the memory writers, and decreases the optimum data amount by the predetermined value with respect to the corresponding memory writer when the result of writing completion is not received from the corresponding memory writer.

5. The memory writing system according to claim 1, wherein the desired data write time condition is equality of a data write time of one memory writer for the nonvolatile memory and a data transmission processing time of the writer controller for four memory writers.

6. The memory writing system according to claim 1, wherein the first setting component, the first transmission controller, the measurement component, the correlation detection component, the second setting component and the second transmission controller are included in the writer controller.

7. A memory writing system comprising a writer controller and a plurality of memory writers, the writer controller sequentially transmitting data to the memory writers over a communication channel and repeating this transmission operation, each of the memory writers, whenever receiving data transmitted from the writer controller, writing the received data into a nonvolatile memory, the system further comprising:
first setting means for setting the amount of data to be transmitted per one-time transmission from the writer controller to different values for the respective memory writers;
first transmission control means for transmitting data of each of the data amounts from the writer controller to a corresponding one of the memory writers;
measurement means for measuring, for each of the data amounts, a processing time required for the writer controller to transmit data to the corresponding memory writer and a data write time of the corresponding memory writer;
correlation detection means for obtaining, for each of the data amounts, a correlation between the processing time and the data write time based on respective measured values of the processing time and data write time measured by the measurement means;
second setting means for setting an optimum data amount based on the correlation to satisfy a desired data write time condition; and
second transmission control means for, after the optimum data amount is set, sequentially transmitting data of the optimum data amount from the writer controller to the memory writers.

8. The memory writing system according to claim 7, wherein the second transmission control means increases/decreases the optimum data amount depending on a writing state of each of the memory writers.

9. The memory writing system according to claim 7, wherein the second transmission control means increases the optimum data amount by a predetermined value with respect to a corresponding one of the memory writers when a result of writing completion is received from the corresponding memory writer at a time corresponding to the optimum data amount after the data of the optimum data amount is transmitted to each of the memory writers, and decreases the optimum data amount by the predetermined value with respect to the corresponding memory writer when the result of writing completion is not received from the corresponding memory writer.

10. The memory writing system according to claim 8, wherein the second transmission control means increases the optimum data amount by a predetermined value with respect to a corresponding one of the memory writers when a result of writing completion is received from the corresponding memory writer at a time corresponding to the optimum data amount after the data of the optimum data amount is transmitted to each of the memory writers, and decreases the optimum data amount by the predetermined value with respect to the corresponding memory writer when the result of writing completion is not received from the corresponding memory writer.

11. The memory writing system according to claim 7, wherein the desired data write time condition is equality of a data write time of one memory writer for the nonvolatile memory and a data transmission processing time of the writer controller for four memory writers.

12. The memory writing system according to claim 7, wherein the first setting means, the first transmission control means, the measurement means, the correlation detection means, the second setting means and the second transmission control means are included in the writer controller.

13. A memory writing method of a memory writing system, the memory writing system comprising a writer controller and a plurality of memory writers, the writer controller sequentially transmitting data to the memory writers over a communication channel and repeating this transmission operation, each of the memory writers, whenever receiving data transmitted from the writer controller, writing the received data into a nonvolatile memory, the method comprising:
a first setting step of setting the amount of data to be transmitted per one-time transmission from the writer controller to different values for the respective memory writers;
a first transmission control step of transmitting data of each of the data amounts from the writer controller to a corresponding one of the memory writers;
a measurement step of measuring, for each of the data amounts, a processing time required for the writer controller to transmit data to the corresponding memory writer and a data write time of the corresponding memory writer;
a correlation detection step of obtaining, for each of the data amounts, a correlation between the processing time and the data write time based on respective measured values of the processing time and data write time measured at the measurement step;
a second setting step of setting an optimum data amount based on the correlation to satisfy a desired data write time condition; and
a second transmission control step of, after the optimum data amount is set, sequentially transmitting data of the optimum data amount from the writer controller to the memory writers.
